(19) United States
(12) Patent Application Publication
(10) Pub. No.: US 2007/0296237 A1
(43) Pub. Date: Dec. 27, 2007

(54) Quick-Release System for Removable Windshields

(76) Inventor: David E. Anderson, Sandy, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/767,358

(22) Filed: Jun. 22, 2007

Related U.S. Application Data
(60) Provisional application No. 60/815,766, filed on Jun. 22, 2006.

(51) Int. Cl. B62J 17/04

(52) U.S. Cl. 296/78.1

(57) ABSTRACT

A system and method is provided for a quickly-detachable and replaceable windshield for a recreational vehicle such as a motorcycle. The system may include a fairing that is configured to include a windshield mounting receptacle and rapid attachment hardware that does not require the use of any tools to actuate the hardware. Also included is a windshield configured to engage the rapid attachment hardware upon insertion of the windshield into the windshield mounting receptacle. In use, the windshield is inserted into the windshield mounting receptacle until it engages the rapid attachment hardware, and may be removed and rapidly replaced without the use of any tools by actuating the rapid attachment hardware to release the windshield.

### CROSS-REFERENCE TO RELATED APPLICATIONS

This application claims the benefit of U.S. Provisional Application No. 60/815,766, filed Jun. 22, 2006.

### BACKGROUND OF THE INVENTION

1. Field of the Invention

The present invention relates to removable windshields, and more particularly to a quickly-removable windshield system for use on motorcycles and other similar situations where an easily-removable windshield from the vehicle is desirable.

2. Background and Related Art

The use of full-size motorcycle windshields is desirable and well known for long-distance highway travel. Such a windshield, when properly placed on a motorcycle, minimizes exposure to windloading on the upper part of the body and consequent fatigue caused thereby, and serves as a protective barrier against rocks and debris which can be projected from other motor vehicles. Accordingly, many motorcycle riders prefer a full-size windshield in contrast to a shorter/smaller windshield. However, when traveling strictly around town or for shorter trips, a motorcycle rider may not wish to have a full-size windshield, or may wish to employ a smaller windshield on the motorcycle. However, removal of a fairing-mounted windshield causes undo wear on connection points on the fairing, which once damaged are often costly and difficult—if not impossible—to repair. Additionally, because the attachment and removal of a fairing windshield involves a number of steps involving tools, such a permanent method of windshield attachment is not necessarily desirable. It is likewise not desirable to have a windshield, which, once removed, leaves protruding or interfering attachment points on the cycle, thus creating an unsightly appearance and a possible injury hazard.

### SUMMARY OF THE INVENTION

The present invention provides a system whereby a removable windshield may be easily inserted, removed or detached, and/or interchanged with other windshields, in a timely manner, without requiring the use of tools or special equipment beyond the initial installation of special mounting hardware, and without harm to existing connection points on the fairing or vehicle. The present invention provides for simple insertion of a windshield, and minimal actuation of a few simple parts to secure and/or remove a windshield. In some embodiments, the windshield, once attached, may be prevented from accidental of unauthorized removal from the motorcycle. The system of the present invention can also be easily adapted to other recreational vehicles where it might be desirable to have a quickly-removable windshield.

### BRIEF DESCRIPTION OF THE DRAWINGS

FIGS. 1a-1c show perspective views of an embodiment of a quickly-removable windshield system in accordance with embodiments of the present invention;

FIG. 1d shows an exploded perspective view of the embodiment from FIGS. 1a-1c;

FIG. 2 shows a sectional view of an embodiment of a mounting bracket in accordance with embodiments of the present invention;

FIG. 3 shows a detail view of a portion of an embodiment of a windshield used with embodiments of the present invention;

FIGS. 4a and 4b show a partial sectional view of an embodiment of attachment hardware for use with embodiments of the present invention;

FIG. 4c shows an exploded perspective view of an embodiment of attachment hardware for use with embodiments of the present invention;

FIG. 5 shows a perspective view of another embodiment attachment hardware;

FIGS. 6-13 show perspective views of portions of various embodiments of attachment hardware for use in embodiments of the inventive system;

FIGS. 14-25 show various perspective views of other embodiments of attachment hardware;

FIG. 26 shows an exploded perspective view of an alternate embodiment of a mounting bracket and windshield;

FIGS. 27a and 27b show front and side perspective views of the center plate of the alternate embodiment from FIG. 26;

FIG. 28 shows a partial sectional view of an alternate embodiment of a mounting bracket, attachment hardware, and windshield;

FIG. 29 shows a partial sectional view of the embodiment of FIG. 28 in a released position;

FIG. 30 shows a partial sectional view of an alternate embodiment of a mounting bracket, attachment hardware, and windshield;

FIG. 31 shows a partial sectional view of the embodiment of FIG. 30 in a released position; and

FIG. 32 shows a plan view of an alternate embodiment of a mounting bracket and attachment hardware.

### DETAILED DESCRIPTION OF EMBODIMENTS OF THE INVENTION

A description of various embodiments of the present invention will now be given with reference to the Figures. It is expected that the present invention may take many other forms and shapes, hence the following disclosure is intended to be illustrative and not limiting, and the scope of the invention should be determined by reference to the appended claims.

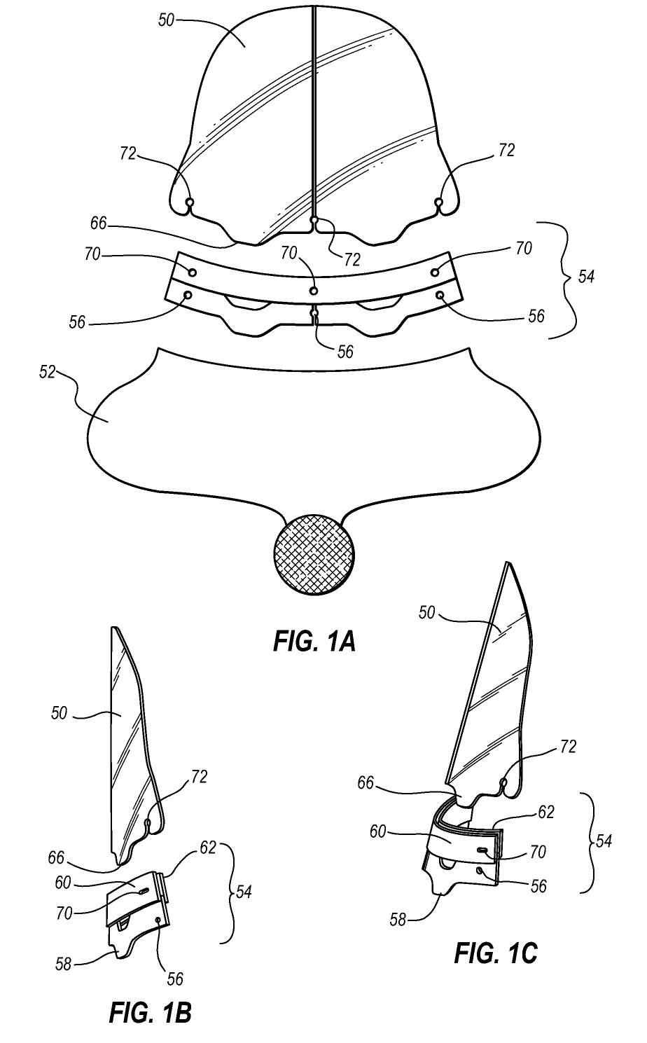

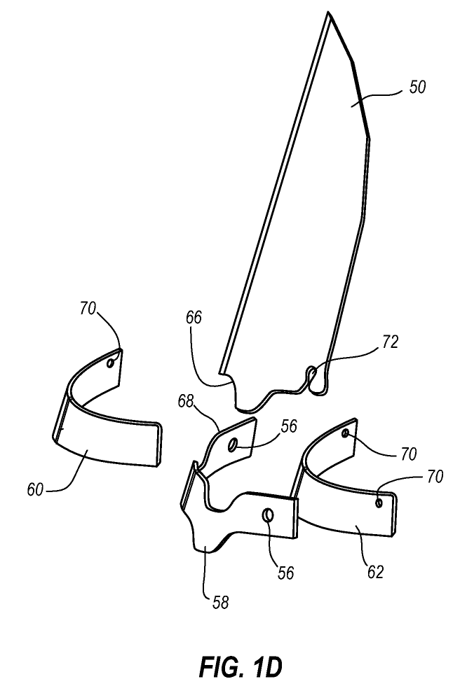

Referring now to FIGS. 1a, 1b, 1c, and 1d, these figures show various views of one embodiment of the inventive system for providing a quickly-detachable windshield 50 for rapidly-releasable and rapidly-interchangeable attachment to a motorcycle fairing 52, as shown in FIG. 1a. In one embodiment, the fairing 52, after attachment to a motorcycle (not shown) has interior mounting points (not shown) to which would normally be affixed a motorcycle windshield by, for example, bolting the windshield to the fairing 52. Such affixation, while secure, results in a time-consumptive process and excessive wear on attachment points of the fairing 52 when the user desires to change the windshield, as described above.

In an embodiment of the present invention, the quickly-detachable windshield 50 is formed out of a unitary piece of material as can be seen in FIG. 1a. This allows for easy and inexpensive manufacturing of the windshield 50, and allows not only for rapid interchangeability of windshields 50 to satisfy the desires and needs of the motorcycle owner, but also allows inexpensive replacement if a windshield 50 is damaged for any reason, such as by being involved in a crash or impact with an object. Furthermore, this method of manufacture reduces the weight of the interchangeable windshield 50 as opposed to methods for providing for a removable windshield that require leaving large amounts of heavy hardware attached to the windshield after removal from the motorcycle or fairing 52.

One embodiment addresses the need for rapid interchangeability of the windshield by interposing a windshield mounting bracket 54 between the windshield 50 and the fairing 52. The windshield mounting bracket 54 may have fairing mounting holes 56 or other attachment points that correspond to the interior mounting points (not shown) of the fairing 52, allowing secure attachment, as by bolting or other methods known in the art (as has occurred in the past to mount the windshield to the fairing). The windshield mounting bracket 54 may thus be securely and more or less permanently attached to the motorcycle fairing 52, and the quickly-detachable windshield 50 may then attach to the windshield mounting bracket 54 instead of attaching to the fairing 52 directly.

It will also be readily apparent to one of skill in the art from this description that the present invention embraces potential changes to the above-described embodiment, such as that of manufacturing the windshield mounting bracket 54 as part of the fairing 52 so that the bracket 54 and fairing 52 form one unitary piece, thus obviating the need to add complexity by mounting the windshield mounting bracket 54 to a fairing 52. Thus, if a fairing 52 did not have a removable windshield in a format that permits adaptation of the windshield mounting bracket 54, the entire fairing 52 could be replaced, either with a new unitary fairing 52 including the features of the windshield mounting bracket 54 that will be described below, or with a new fairing 52 that could accept a windshield mounting bracket 54, to allow rapid detachment and interchanging of the quickly-detachable windshield 50 of the present invention. In this manner, either the fairing 52 itself (modified as described above) or a windshield mounting bracket 54 can serve as a windshield mounting receptacle. Additionally, one of skill in the art will readily appreciate that a windshield mounting bracket 54 may be provided and directly attached to the motorcycle without being attached to a fairing, and in some such embodiments, the motorcycle and the quickly-detachable windshield 50 may be used with no fairing 52 at all.

While the illustrated shape of the windshield mounting bracket 54 provides some advantages in strength and aiding in the seating of the quickly-detachable windshield 50 of the present invention, it is envisioned that the windshield mounting bracket 54 (or unitarily-constructed fairing 52 that includes the features of the windshield mounting bracket 54) could take any number of functional or decorative shapes that would still allow for the functionality of the present invention while suiting the needs and desires of the individual motorcycle owner and rider. Furthermore, the quickly-detachable windshield 50 of the present invention could optimally take any of a large number of shapes, heights, widths, opacities, colors, and other features, while still embracing the features of the present invention. It is also envisioned that the embodiments of the present invention could be adapted for any number of other situations or recreational vehicles, such as snowmobiles, ATVs, motorboats and other small watercraft, or any other situation where the user desires the ability to be able to change the look and functionality of his or her vehicle by easily and quickly changing the windshield or other similarly-shaped/similarly-functional attachment.

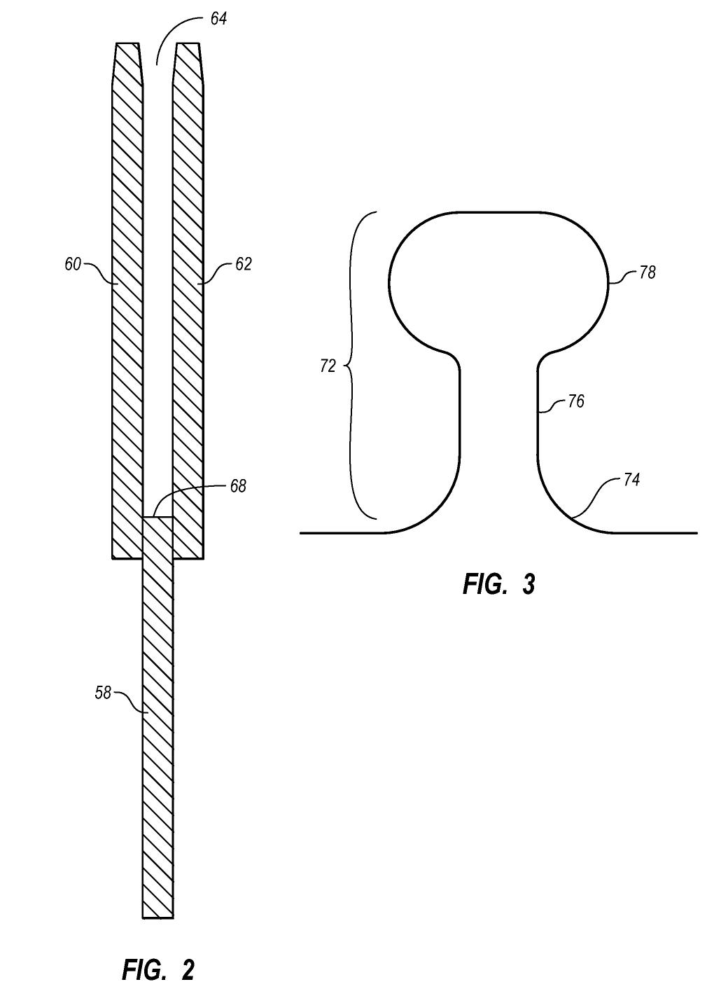

Turning back to the windshield mounting bracket 54, one embodiment of the windshield mounting bracket 54 will now be described. In the described embodiment, the windshield mounting bracket 54 may be manufactured from three curved metal plates. A center bracket plate 58 is placed between a front bracket plate 60 and a back bracket plate 62 in a manner to provide a secure connection (such as by welding, riveting, cementing, gluing, screwing, bolting, etc.) between the front bracket plate 60 and the back bracket plate 62 while also defining a gap 64 between the front bracket plate 60 and the back bracket plate 62, as can be optimally seen in cross-section in FIG. 2. Although the various plates 58, 60, 62 are illustrated in FIG. 2 as being of similar thickness, the present invention envisions that the various plates 58, 60, 62 might be chosen to be of different or even varying thicknesses in certain embodiments, as will be clear from the description below.

In the illustrated embodiment, the gap 64 defined between the front bracket plate 60 and the back bracket plate 62 by the center bracket plate 58 may be sized to snugly and securely accept the quickly-detachable windshield 50 by sliding the windshield 50 approximately vertically downward into the gap 64 until a lower edge 66 of the windshield 50 rests in contact with an upper edge 68 of the center bracket plate 58. As can best be seen in FIG. 1a, the lower edge 66 of the quickly-detachable windshield 50 and the upper edge 68 of the center bracket plate 58 may optimally be shaped to aid in the proper alignment and seating of the quickly-detachable windshield 50 into the windshield mounting bracket 54 during the attachment process.

The snug fit of the quickly-detachable windshield 50 in the gap 64 between the front bracket plate 60 and the back bracket plate 62 provides a secure hold of the windshield 50 to prevent unwanted vibrations between the fairing 52 and the windshield 50. While one embodiment includes bracket plates 58, 60, 62 that are substantially solid and extend the full length of the windshield mounting bracket 54 to provide maximum security of attachment of the windshield 50, the present invention also encompasses other embodiments, including embodiments where the plates are made of materials other than metal, such as strong plastics, fiberglass, and polycarbonate, and also embraces other forms where the individual plates might be much more limited in size and shape and only extend a length sufficient to provide secure attachment of the windshield 50 to the fairing 52. Such might particularly be the case in a situation where a unitary fairing 52 has been manufactured to provide the advantages of the present invention without the need for a separate windshield mounting bracket 54. In other embodiments, as may be appreciated by one of skill in the art, the center bracket plate 58 may be integrally formed as a jog in either the front bracket plate 60 or the back bracket plate 62. In still other embodiments, the center bracket plate 58 may be omitted entirely, and the quickly-detachable windshield 50 may be secured entirely by the front bracket plate 60 and the back bracket plate 62, however such plates 60 and 62 are sized and shaped.

In the embodiment illustrated in FIGS. 1a-1d, the windshield mounting bracket 54 has windshield attachment points 70 that interact with shaped notches 72 placed in the lower edge 66 of the quickly-detachable windshield 50, as best seen in FIGS. 1a, 1b, and 1c. When the quickly-detachable windshield 50 is lowered to its full extent in the gap 64 between the front bracket plate 60 and the back bracket plate 62 of the windshield mounting bracket 54, the user may manipulate special hardware (not shown in FIGS. 1a-1d but to be described in full below) that interacts with the notches 72 in the lower edge 66 of the windshield 50 and locks the windshield 50 in place, preventing inadvertent or undesired vertical movement of the windshield 50 relative to the windshield mounting bracket 54 (and the fairing 52).

The hardware located at the windshield attachment points 70 is designed to provide a quick but secure connection between the windshield 50 and the windshield mounting bracket 54 (or fairing 52 in the case of a unitarily-designed fairing 52), and is described in full below. While the illustrated embodiment shows three windshield attachment points 70 and corresponding notches 72, one of skill in the art may readily appreciate that the number of attachment points could easily be changed, and the invention embraces having only one windshield attachment point 70 and corresponding notch 72, or having two, four, or any other number of windshield attachment points 70 and corresponding notches 72. Although the windshield attachment points 70 are illustrated as being visible from the front in FIGS. 1a-1c, the present invention embraces attachment hardware and windshield attachment points that are visible from the front and/or the back, but normally the back only, as displayed in FIG. 1d, so as to conceal from a mere cursory glance the fact that the quickly-detachable windshield 50 is readily detachable.

Furthermore, while one shape of the notches 72 placed in the lower edge 66 of the quickly-detachable windshield 50 is shown in FIGS. 1a-1d, the present invention embraces all other shapes for the notches 72 that preserve the functionality of the present invention and allow for the functionality of the attachment hardware that will be described below.

So that the advantages of the present invention can be fully appreciated, a description of various embodiments of the attachment hardware will be described, with reference to the appended Figures. The various embodiments discussed herein form a subset of attachment hardware that may be referred to as “rapid attachment hardware” in the appended claims.

Referring now to the Figures, FIG. 3 illustrates one shape of the notches 72 placed in the quickly-detachable windshield 50 of certain embodiments of the present invention. The notch 72 has a flared base 74 that may aid in aligning and seating of the quickly-detachable windshield 50 with the windshield mounting bracket 54 or unitary fairing 52. Just above the flared base 74, the notch 72 has a narrow neck 76 that finishes alignment, permits passage of a portion of the attachment hardware, and, once the hardware is locked in place, prevents unwanted removal and vertical movement of the quickly-detachable windshield 50. Finally, the notch 72 has a flared opening 78 that accepts a locking portion of the attachment hardware and that may prevent upward vertical movement of the quickly-detachable windshield 50 due to the mechanical interaction of the lower edge of the flared opening 78 and the attachment hardware, as will become clear from the following description.

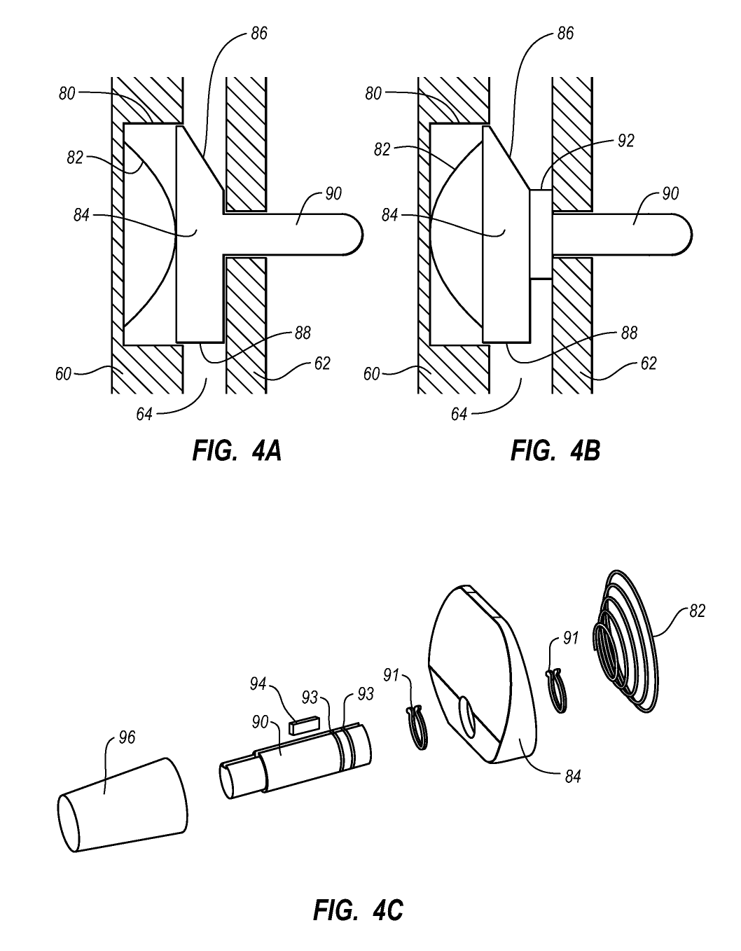

FIGS. 4a-4c show embodiments of the attachment hardware mentioned above. FIGS. 4a and 4b are partial sectional views of embodiments of attachment hardware as located in/on an embodiment of the windshield mounting bracket 54, while FIG. 4c is an exploded perspective view of an embodiment of the attachment hardware. In FIG. 4a, the front bracket plate 60 is substantially thicker than the center bracket plate 58 (not shown) and, hence, the front bracket plate 60 is correspondingly thicker than the gap 64 that corresponds to the thickness of the quickly-detachable windshield 50 (not shown) and the center bracket plate 58. In this configuration, the back bracket plate 62 may be of any desired thickness that provides sufficient strength, but is shown in FIG. 4a as having a thickness corresponding to the center bracket plate 58 (not shown).

During manufacture, the front bracket plate 60 is provided with a recess 80 which receives a spring 82 and a plunger head 84. The plunger head 84 is sized and shaped to fit slidably but snugly within the recess 80 and also to fit within the flared opening 78 of the quickly-detachable windshield 50. The plunger head 84 may be sized and shaped (along with the recess 80) so that the plunger head 84 substantially completely fills the flared opening 78, at least along its width, to provide the most secure hold on the windshield 50. Furthermore, the plunger head 84 may be made to have a thickness slightly larger than the thickness of the gap 64 so as to prevent accidental loss of the spring 82 from the space defined by the recess 80 between the back surface of the front bracket plate 60 and the plunger head 84. To further prevent loss, the spring 82 may also optionally be attached to either the front bracket plate 60 within the recess 80 or to the plunger head 84 so as to be within the recess 80.

The plunger head 84 may optionally be provided with an angle or cant 86, as seen in FIGS. 4a and 4b, on the upper surface of the plunger head only. This may be done so that when the quickly-detachable windshield 50 is placed in the gap 64 moving in a downward substantially-vertical direction, the windshield 50 interacts with the angle or cant 86 of the plunger head 84, forcing the plunger head out of the way of the windshield 50 by pressing the plunger head 84 against the force of the spring 82 and into the recess 80. When the quickly-detachable windshield 50 reaches its most downward position, the flared opening 78 of the notch 72 in the windshield 50 corresponds in location to the plunger head 84, allowing the force of the spring 82 to force the plunger head 84 back into its resting position within the gap 64. In this position, the plunger head 84 is now within the flared opening 78, and the flat bottom 88 of the plunger head 84 prevents an upward force applied on the windshield 50 from being translated into a horizontally-dislocating force on the plunger head 84. In this fashion, the plunger head 84 locks the quickly-detachable windshield 50 in place, preventing unwanted upward movement of the windshield 50, that is, preventing unwanted removal of the windshield 50.

Rapid detachment, when desired, may be provided by a plunger shaft 90 which is attached to the back side of the plunger head 84 as can be clearly seen in FIGS. 4a and 4b. The plunger shaft 90 extends out through a small hole in the back bracket plate 62 of the windshield mounting bracket 54. The plunger shaft 90 allows a user to apply a horizontal force to the plunger head 84 through the plunger shaft 90 by pressing on the protruding portion of the plunger shaft 90. This horizontal force may displace the plunger head 84 until the flat bottom 88 of the plunger head 84 is fully or largely within the recess 80 of the front bracket plate 60 so as to no longer be within the space defined by the flared opening 78 and the gap 64. At this point, the plunger head 84 no longer prevents removal of the quickly-detachable windshield 50. Thus, one skilled in the art can readily see how the present invention provides for the easy and quick detachment of the quickly-detachable windshield 50 of the described embodiments of the present invention to allow for rapid interchangeability of a motorcycle or other vehicle's windshield or other similar part. As is also readily apparent to one skilled in the art, the placement of the narrow neck 76 of the notch 72 permits passage of the quickly-detachable windshield 50 over the combination of the plunger head 84 and plunger shaft 90, as the plunger shaft 90 passes through the narrow neck 76 of the notch 72 and the plunger head 84 is pressed out of the way while the quickly-detachable windshield 50 is inserted or removed.

Referring now to FIG. 4b, another embodiment is shown in which the front bracket plate 60, the center bracket plate 58 (and optionally the back bracket plate 62) are all of substantially the same width. As before, the thickness of the back bracket plate 62 has little significance beyond providing any necessary strength for supporting the quickly-detachable windshield and the mounting hardware. In this configuration, an additional feature is employed to provide proper functionality of the plunger head 84. This feature is a small plunger washer 92 interposed between the plunger head 84 and the plunger shaft 90. This plunger washer 92 holds the end of the plunger head 84 within the recess 80 to prevent loss of the spring 82. As is readily appreciable by one of skill in the art, the plunger washer 92 need not be a separate piece, but may be manufactured as an integral part of the plunger head 84.

The advantage of the configuration of FIG. 4b is that it is not necessary to provide for differing thicknesses of the various bracket plates 58, 60, 62 when manufacturing the windshield mounting bracket 54. In the illustrated embodiment, the quickly-detachable windshield 50 may be slightly thinner than the gap 64, or the windshield may be manufactured with localized regions of thinness surrounding the narrow neck 76 of the notch 72 to allow the windshield material to pass by the plunger head 84 during insertion of the windshield 50. Alternatively, the narrow neck 76 may be slightly widened so as to pass around the plunger washer 92 during windshield insertion or removal. An advantage of the configuration of FIG. 4a is that it reduces the need for making any portion of the windshield thinner or widening the narrow neck 76, but it requires differing thickness between at least the front bracket plate 60 and the center bracket plate 58.

Although the above description indicates that the external portions of the attachment hardware are accessible through the back bracket plate 62, one of skill in the art can readily appreciate that the orientation described above could easily be reversed so that the recess 80 to accept the plunger head 84 is provided in the back mounting plate 62, while the plunger shaft 90 passes through a small hole in the front bracket plate 60, without adversely affecting the functionality of the windshield attachment point 70 and attachment hardware described.

It is also anticipated that other changes could be provided to achieve the same functionality of the present invention. For example, the recess 80 could be provided on the same bracket plate (either the front bracket plate 60 or the back bracket plate 62) as the hole through which the plunger shaft 90 passes, so that a pulling force instead of a pushing force may be applied to the plunger shaft 90 to displace the plunger head 84 and allow passage of the quickly-detachable windshield 50. In such a system, the notch 72 in the quickly-detachable windshield 50 might be replaced by a hole, a recess, or an indentation in the windshield 50, located at a position corresponding to the flared opening 78 described above, to receive the plunger head 84. In such an embodiment, the notch 72 would not be necessary to allow passage of the plunger shaft 90 during insertion of the windshield 50, as all portions of the attachment hardware are displaced to a single side of the passing windshield 50 with no plunger shaft 90 remaining in the path of the windshield 50, as will be appreciated by one of skill in the art.

Furthermore, while the angle or cant 86 provided on the plunger head 84 allows entry of the windshield without requiring someone to apply force to the plunger shaft 90 to move the plunger head 84 out of the way, the angle or cant 86 could optionally be removed to leave a flat top to the plunger head 84. Such embodiments require some force external force applied to the attachment hardware (i.e. the plunger shaft 90) during insertion of the quickly-detachable windshield 50 as well as during removal. Finally, while the plunger shaft 90 is depicted in FIGS. 4a and 4b as being a simple shaft, it may also be changed to include a flared or enlarged head or thumb pad on its exterior end to make application of the displacing force easier for the user.

In some embodiments, it is desirable to provide security for the windshield attachment system shown in FIGS. 4a and 4b, so that would-be thieves cannot easily remove the quickly-detachable windshield 50 of the present invention. To that end, the plunger shaft 90 may be made detachable from the plunger head 84 (and/or plunger washer 92) so that the plunger shaft 90 (or a protruding portion thereof) may be removed to leave only a small discreet hole in the back bracket plate 62. In such embodiments, it is envisioned that the remaining hole would not attract the attention of thieves and would require would-be thieves to have a compatible replacement plunger shaft 90 to release the plunger head 84 and steal the quickly-detachable windshield 50. This could be accomplished by, for example, machining screw threads into the plunger shaft 90 and plunger head 84 so that the plunger shaft 90 screws into the plunger head 84, or by manufacturing the plunger shaft 90 in two parts that screw into one another to leave a small portion of the plunger shaft 90 within the hole in the back bracket plate 62. Leaving a small portion of the plunger shaft 90 within the hole may assist in the maintenance of the proper position of the plunger head 84 within the gap 64 between the front bracket plate 60 and the back bracket plate 62.

FIG. 4c shows an exploded perspective view of a disassembled attachment hardware embodiment similar to the embodiments shown in FIGS. 4a and 4c. In this embodiment, the plunger shaft 90 may be provided with a thumb grip 96 to provide a greater surface area to which to apply force. The plunger shaft 90 is designed to pass through the plunger head 84, and be retained by a pair of retaining clips 91 that fit in retaining clip grooves 93 on the plunger shaft 90. Although one shape of retaining clips 91 and retaining clip grooves 93 is shown, it is anticipated that any number of shapes that secure plunger head 84 to plunger shaft 90 would function acceptably. In this embodiment, the connection between the plunger shaft 90 and the plunger head 84 is rotatable. Alternatively, a notch and tab may be provided on the plunger shaft 90 and plunger head 84 to prevent rotation, or the plunger shaft 90 may be non-cylindrical to prevent rotation if desired. Also shown in FIG. 4c is an alternate shape for spring 82. One of skill in the art can readily appreciate that the plunger head 84 of the embodiment illustrated in FIG. 4c may be sized similarly to either of the embodiments shown in FIGS. 4a and 4b in conjunction with the recess 80 and thickness of the front bracket plate 60 described above, as desired. One of skill in the art will also recognize that the shape of the spring 82 and the type of spring used for spring 82 may vary, and may include coiled springs such as illustrated in FIG. 4c, flex washers, spring washers, or any other type of spring or elastic member.

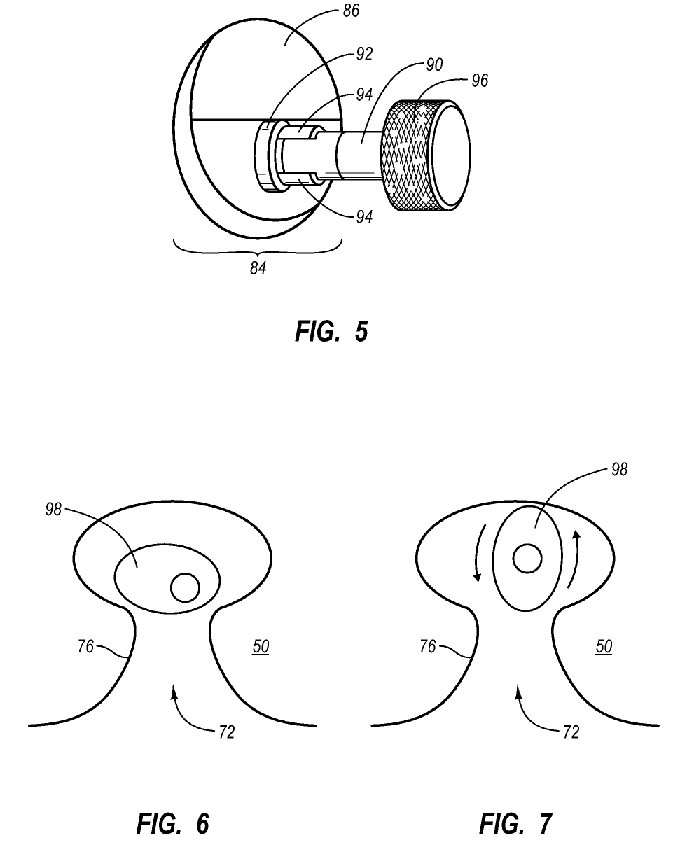

As the number of windshield attachment points 70 increases, the security of the connection between the quickly-detachable windshield 50 and the windshield mounting bracket 54 or unitary fairing 52 increases; however, it may become more difficult for a user that wishes to remove or interchange quickly-detachable windshields 50 to apply force to all the necessary plunger shafts 90 to allow detachment of the windshield 50. For this reason, various modifications to the plunger shaft 90 and hole in the back bracket plate 62 may be provided in some embodiments, as illustrated in FIGS. 4c and 5.

FIG. 4c shows a small pin or locking tab 94 that may be added to the plunger shaft 90, such as in a corresponding groove in the plunger shaft 90. The pin or locking tab 94 may be used in embodiments of the plunger head 84 and plunger shaft 90 assembly to lock the plunger head 84 in a position where the plunger head 84 is out of the path of the quickly-detachable windshield 50 during vertical insertion or removal of the windshield 50. In the embodiment shown in FIG. 4c, the pin or locking tab 94 may be attached to the plunger shaft 90 by any means known in the art, such as by welding, a frictional press fit, by casting the pin or locking tab 94 as part of the plunger shaft, gluing, cementing, or any other known secure method of attachment. For example, in one embodiment, the pin or locking tab 94 may be tightly inserted by a press fit into a groove on the plunger shaft 90 at a time when the plunger shaft 90 has been heated to expand the groove. When the plunger shaft 90 cools, the groove contracts and securely holds the pin or locking tab 94. The longitudinal location of the pin or locking tab 94 may be chosen to provide the locking functionality described herein, as will be readily appreciated by one of skill in the art by reference to the Figures and through practicing the invention.

In embodiments such as that illustrated in FIG. 4c, the hole in the back bracket plate 62 (or front bracket plate 60, depending on the embodiment) may be modified into a keyhole shape to permit selective passage of the pin or locking tab 94. In use, the plunger shaft 90 may be pushed or pulled, depending on the embodiment and the corresponding location of the recess 80, until the plunger head 84 is no longer in the path of the windshield 50. Once the plunger head 84 is no longer in the path of the windshield 50, the pin or locking tab 94 is no longer within the keyhole shape, and the shaft 90 may be rotated (such as by the thumb grip 96) so that the pin or locking tab 94 engages the side of the hole through which the plunger shaft 90 passes and effectively locks the plunger head 84 in a position out of the path of the windshield 50 during windshield insertion or removal. In this and similar manners, the windshield 50 may be easily removed and inserted without requiring continual manual pressure on the rapid attachment hardware. When the windshield 50 is fully removed or fully in place, the shaft 90 may be rotated again until the pin or locking tab 94 aligns with the keyhole-shaped hole, and the force of the spring 82 returns the plunger head 84 to its windshield-locking position.

Similarly, in FIG. 5, another embodiment of the plunger head 84 and plunger shaft 90 assembly is shown. In FIG. 5, the angle or cant of the plunger head 86 is also visible. The plunger shaft 90 is rotatably connected to the plunger head 84 at the plunger washer 92 in this embodiment, and a pair of locking tabs 94 have been added on either side of the plunger shaft 90 proximate to the rotatable connection at the plunger washer 92. On the distal end of the plunger shaft 90 is placed a thumb grip 96 which aids in rotating the plunger shaft 90 and locking tabs 94. The hole in the back bracket plate 62 (not shown) is modified to be roughly oval or elongated in at least part of its interior length instead of being cylindrical, such that in one rotational position of the plunger shaft 90 the locking tabs are able to be placed entirely within the hole in the back bracket plate 62 up to the point where the plunger washer 92 is in contact with the surface of the back bracket plate 62 to allow the plunger head 84 to perform its function of holding the quickly-detachable windshield 50 in place.

In use, this version of the mechanism allows the user to press on the plunger shaft 90 by applying longitudinal (horizontal) force to the thumb grip 96 until the locking tabs 94 are entirely within the gap 64 and outside the hole in the back bracket plate 62. At this point, the plunger shaft 90 is free to rotate about its cylindrical axis due to the rotatable connection with the plunger head, and the plunger shaft 90 may be rotated about this axis roughly ninety degrees by applying rotational force to the thumb grip 96, at which point the longitudinal force to the thumb grip 96 and from the user may be released. When the longitudinal force is released, the locking tabs 94 engage the edges of the hole in the back bracket plate 62, holding the plunger head 84 in a position clear from impeding the vertical movement of the quickly-detachable windshield 50. In this way, any number of mechanisms of this sort may be simultaneously pressed and actuated to release a quickly-detachable windshield 50 and interchange the windshield 50 with another windshield 50.

As is suggested by FIG. 5, the plunger shaft 90 may be manufactured in two pieces as discussed previously to prevent theft. When the plunger shaft 90 is rotated so that the locking tabs 94 are within the hole in the back bracket plate 62, a rotational force may be applied to the thumb grip 96 to unscrew the thumb grip 96 and part of the plunger shaft 90 from the remaining part of the plunger shaft 90 to leave only the appearance of a small hole and deter would-be thieves.

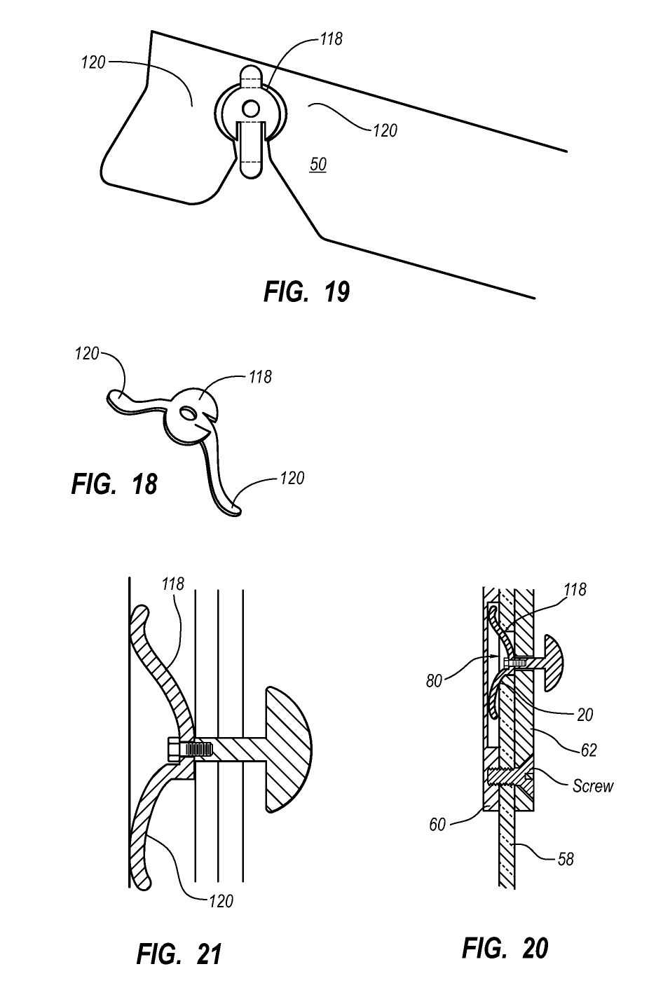

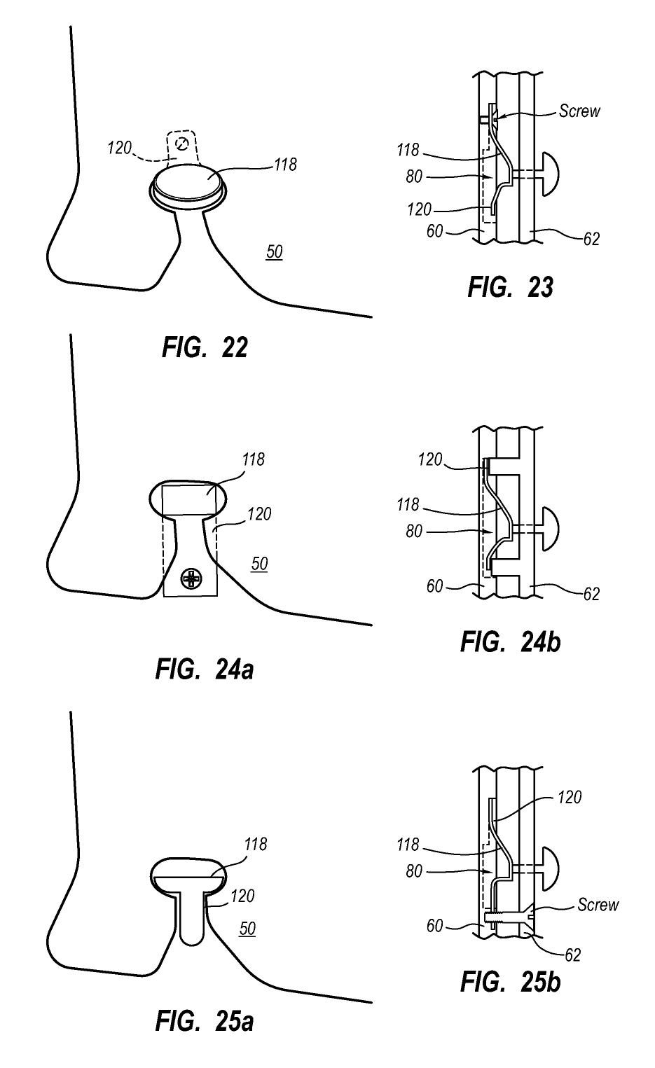

In the following Figures, FIGS. 6-25, the embodiments of the mechanisms (the attachment hardware) used to secure the quickly-detachable windshield 50 to the fairing 52 or windshield mounting bracket 54 are depicted in conjunction with a portion of the quickly-detachable windshield 50 as they would be encountered sandwiched between the front bracket plate 60 and the back bracket plate 62, in most instances without the bracket plates 58, 60, or 62 being depicted. FIGS. 6 and 7 show two embodiments of a locking mechanism to secure the quickly-detachable windshield 50, where the notch 72 in the windshield 50 passes over a rotatable lock 98 when the rotatable lock 98 is in one position, as in FIG. 7, and then the rotatable lock 98 is rotated to a position where the rotatable lock 98 is too wide to fit through the narrow neck 76 of the notch 72 and thus secures the quickly-detachable windshield to the fairing 52 or windshield mounting bracket 54. The means used to rotate the rotatable lock 98 may optionally be removable for security purposes as discussed above. Alternatively, in some embodiments, the means used to rotate the rotatable lock 98 (or to actuate any attachment hardware discussed above or below) may not be attached to the attachment hardware but may simply be inserted into the attachment hardware during windshield removal (and/or insertion).

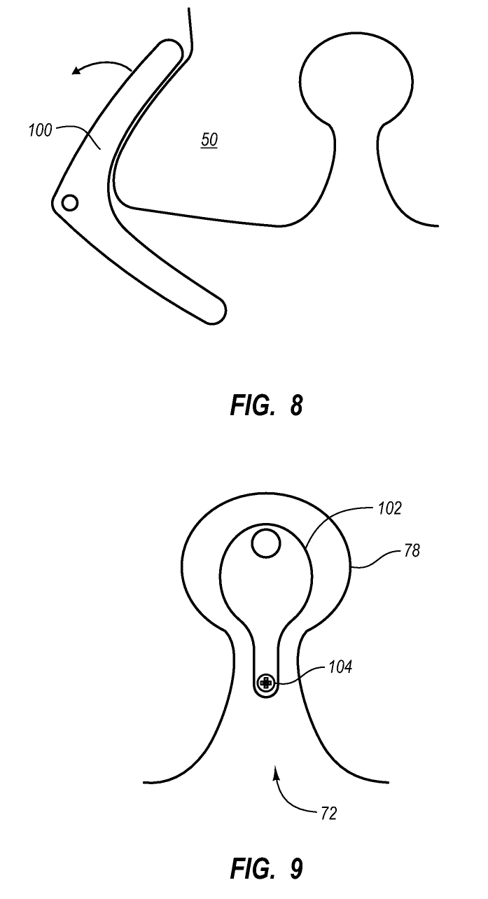

Alternatively or additionally, a portion of the quickly-detachable windshield 50 may be shaped to engage a pivoting lock 100 as depicted in FIG. 8. The pivoting lock 100 may be concealed or partially-concealed. Through the use of several such devices, or in conjunction with other mechanisms described herein, the quickly-detachable windshield 50 may be secured to the motorcycle.

Several embodiments of the present invention rely on the movement of springs to provide a locking mechanism to secure the quickly-detachable windshield 50 to the windshield mounting bracket 54 or fairing 52. Embodiments of such devices are depicted in FIGS. 9-13. In FIG. 9, a center spring clip 102 is attached to at least one of the bracket plates 58, 60, or 62 at a fixed spring attachment point 104. The center spring clip 102, shown as roughly a tear-drop shape in FIG. 9, compresses inward when the windshield is pushed down from the top. When the windshield is in place, the center spring clip 102 will expand back into shape and secure the windshield.

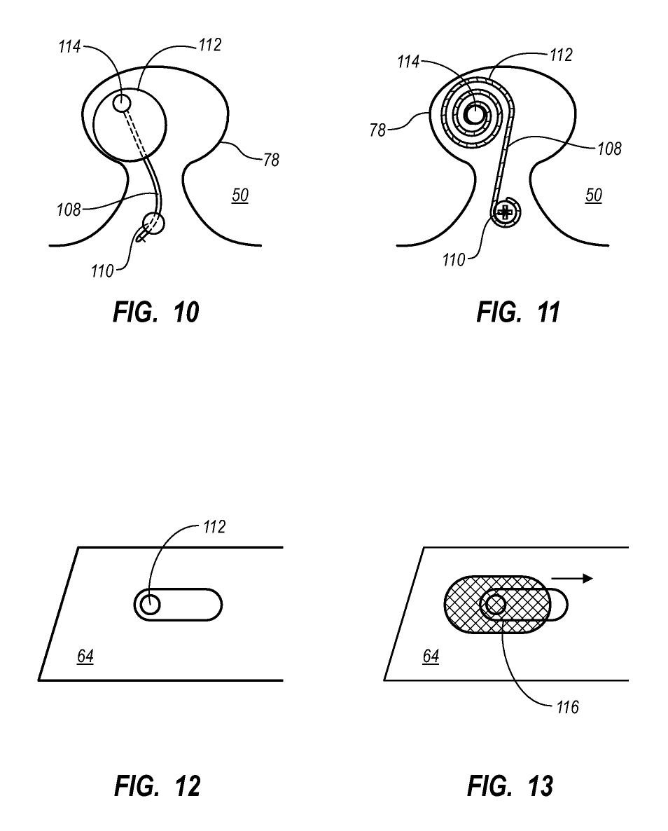

In FIGS. 10 and 11, a spring lock is illustrated. The spring lock is made from a spring 108, an anchor 110, and a lock head 112. The lock head 112 may be a separate piece, as illustrated in FIG. 10, or it may be a continuation of the spring 108 itself, as illustrated in FIG. 11. The anchor 110 is firmly attached to at least one of the bracket plates 58, 60, or 62 and provides a fixed pivot point against which the spring 108 may exert a horizontal springing force against the lock head 112 along the plane of the gap 64 defined between the front bracket plate 60 and the back bracket plate 62. The lock head 112 may also contain a post 114 that allows the user to actuate the spring lock through either the front bracket plate 60 or the back bracket plate 62. The post 114 is further located within a notch in the back bracket plate 64 or the front bracket plate 62 as shown in FIG. 12. The notch allows the post 114 to move in a horizontal direction to actuate the spring lock by moving the lock head 112. This may be done by attaching a thumb plate 116, as seen in FIG. 13 and applying a horizontal force to the thumb plate 116 which is transferred to the lock head 112 through the post 114. The thumb plate 116 may be removable to increase security, as discussed above.

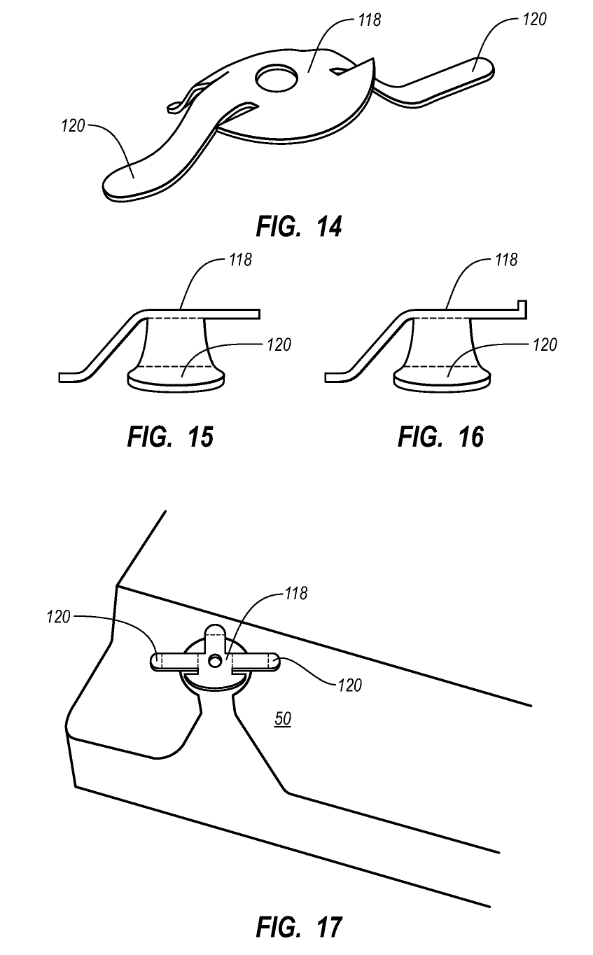

Various configurations and views of another embodiment or type of locking device along with various examples of placing and attaching these types of device are shown in FIGS. 14-25. This device may be made out of a unitary piece of material such as metal, and shaped to form an elastically-deformable clip 118. The elastically-deformable clip 118 is placed so as to be attached to or nestled within a recess 80 in one of the bracket plates 60, 62 and to engage the flared opening 78 of the notch 72 as previously described. The elastically-deformable clip 118 has elastic arms 120 that hold the elastically-deformable clip 118 outside the recess 80 until a force is applied to elastically deform the elastic arms 120 and press the body of the elastically-deformable clip into the recess to allow the quickly-detachable windshield 50 to pass by the elastically-deformable clip for attachment or removal. As described with other embodiments, this deforming force may be applied by the passage of the quickly-detachable windshield 50 during attachment or may be applied by the use of a plunger or actuator (not shown) to apply force to the elastically-deformable clip 118 through a small hole in one or more of the bracket plates 60, 62, as can be seen from the Figures. In some embodiments, the plunger or actuator may be removable, as previously discussed.

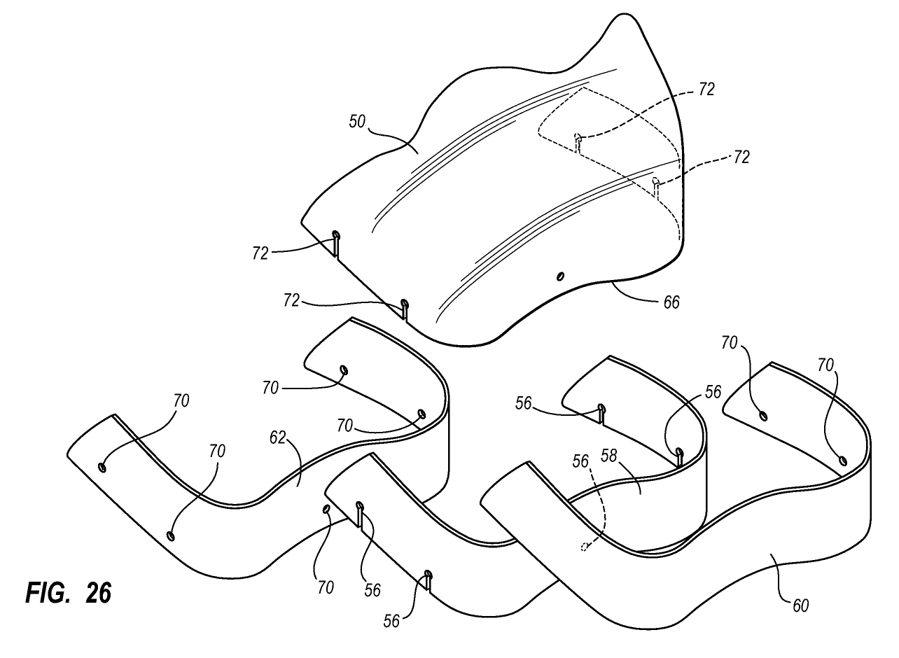

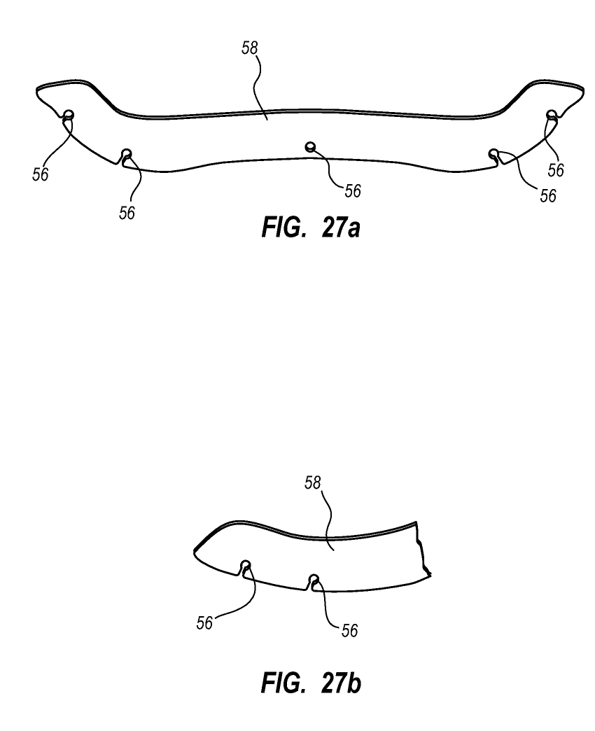

The present invention may be embodied in other specific forms. For example, the shape, size, and contour of the motorcycle fairing and windshield may vary significantly depending on the motorcycle and the user's desires. These changes have no effect on the essential functioning of the invention as long as a windshield may be quickly detachable as described above using a system similar to that described. For example, reference is made to FIGS. 26, 27a, and 27b which show an alternate embodiment of the windshield mounting bracket 54 and quickly-detachable windshield 50. As may be seen from FIGS. 26, 27a, and 27b, the lower edge 66 of the windshield 50 is of a more-rectangular shape. The notches 72 and windshield attachment points 70, as well as the fairing mounting holes 56, are provided in an arrangement with two per side. Thus, although the shape of the windshield 50 and the windshield mounting bracket 54 are significantly different from the shape shown in FIGS. 1a-1d, the same basic functionality is maintained.

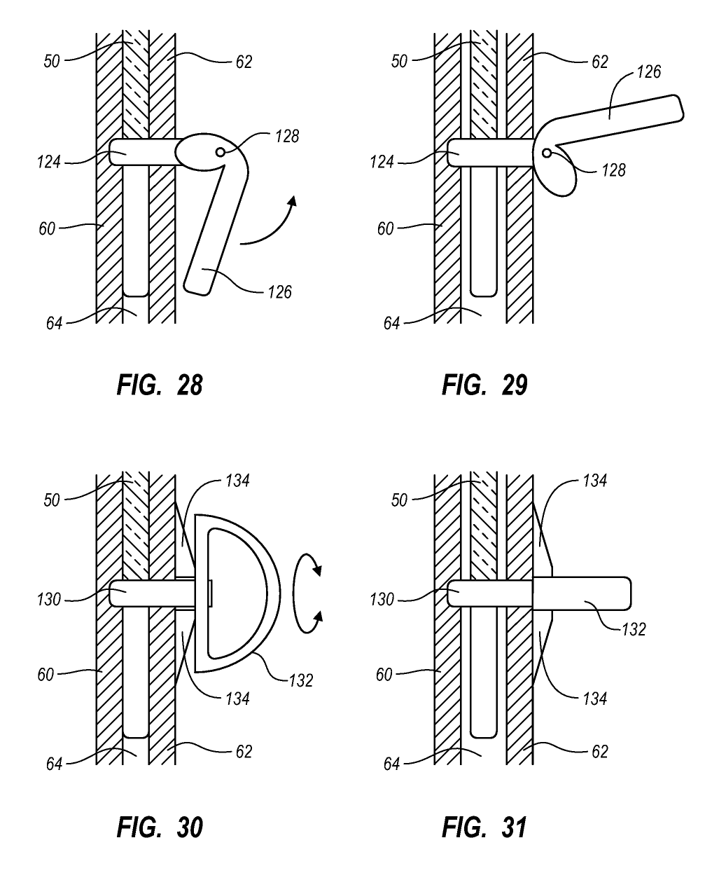

FIGS. 28-31 show partial sectional views of alternate embodiments of the invention that rely on clamping, pressure, and/or friction to engage the quickly detachable windshield 50. The embodiments illustrated in FIGS. 28-31 show the front bracket plate 60, the back bracket plate 62, and the quickly-detachable windshield 50 inserted in the gap 64 between the front bracket plate 60 and the back bracket plate 62. The embodiments illustrated in FIGS. 28-31 may have a center bracket plate 58, or the center bracket plate 58 may be omitted. Where the center bracket plate 58 is provided in such embodiments, it may be attached to one or both of the front bracket plate 60 and the back bracket plate 62 in such a way as to permit some expansive and compressive relative movement between the front bracket plate 60 and the back bracket plate 62. The relative movement permits the gap 64 to be contracted and expanded to clamp onto and release the quickly-detachable windshield, respectively. In embodiments where the center bracket 58 is omitted, the attachment hardware may be the only mechanism securing the front bracket plate 60 to the back bracket plate 62. In such embodiments, either or both of the front bracket plate 60 and the back bracket plate 62 may be attached to the motorcycle or motorcycle fairing 62.

Turning specifically to the embodiment illustrated in FIGS. 28 and 29, this embodiment includes a shaft 124. The shaft 124 is attached to the front bracket plate 60 by any secure means known in the art, such as by welding, bolting, screwing, riveting, cementing, gluing, etc. The shaft 124 may extend through the front bracket plate 60 or may terminate within the front bracket plate 60, as shown. In some embodiments, the shaft 124 may be rotatably fixed to the front bracket plate 60. The shaft 124 is secured to a cam 126 by a pivot pin 128. A head portion of the cam 126 is shaped so that actuating the cam 126 in the manner shown in FIG. 28 reduces pressure applied by the head portion of the cam 126 on the back bracket plate 62 so that the back bracket plate 62 may separate from the front bracket plate 60. This separation and action of the cam 126 releases or applies pressure on the quickly-detachable windshield 50, allowing the windshield 50 to be secured in the windshield mounting bracket 54 when desired, and quickly released when desired as well.

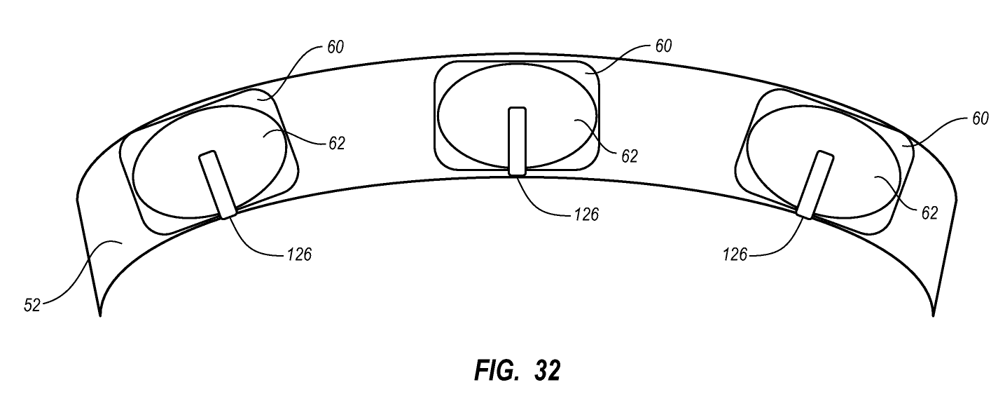

FIGS. 30 and 31 illustrate another system for using pressure to secure the quickly-detachable windshield 50. This system includes a shaft 130 similar to the shaft 124 discussed above in relation to FIGS. 28 and 29, and attached to the front bracket plate 60. The shaft 130 is attached to a rotating handle 132. In some embodiments, the shaft 130 may be attached to the rotating handle 132 by a rotating attachment. In other embodiments, the shaft 130 may be attached to the rotating handle 132 by a fixed attachment and the shaft 130 may be attached to the front bracket plate 60 by a rotating attachment. The outer surface of the back bracket plate 62 is provided with a pair of separators 134 that separate the outer surface of the back bracket plate 62 from the rotating handle 132 when the rotating handle 132 is in a first rotational position, illustrated in FIG. 30, and allow the rotating handle 132 to more-closely approach the back bracket plate 62 when the rotating handle 132 is in a second rotational position, illustrated in FIG. 31. In this way, turning the rotating handle 132 in the manner illustrated in FIG. 30 permits widening or narrowing the gap 64 for releasing or securing the quickly-detachable windshield 50. As may be appreciated by one of skill in the art, the separators 134 may be wedge-shaped to facilitate rotation of the rotating handle 132 as the windshield 50 is secured.

As may be further appreciated by one of skill in the art, the embodiments of FIGS. 28-31 and other such embodiments relying on a clamping, frictional fit do not necessarily rely on a mechanical engagement between the attachment hardware and the quickly-detachable windshield 50. Therefore, the notch 72 of the windshield 50 may be altered, such as by removing the flared opening 78. Additionally, though not specifically illustrated in the Figures, to improve the security of the engagement between the windshield 50 and the windshield mounting bracket 54, one or more of the inner surfaces of the front bracket plate 60 and the back bracket plate 62 may be provided with a higher-friction surface contacting and better securing the windshield 50. For example, such a surface may be provided by roughening the desired surface of the front bracket plate 60 or the back bracket plate 62. Alternatively, a separate material may provide the higher-friction surface, such as a rough material, a rubber material, a sponge rubber material, etc., attached to at least one of the bracket plates 60, 62.

As may be appreciated by one of skill in the art, the front bracket plate 60, the back bracket plate 62, and/or the center bracket plate 58 (when present) need not be continuous plates and need not cover an entire lower portion of the quickly-detachable windshield 50. For example, in one embodiment, the front bracket plate 60 may be a continuous plate or may be provided in several separate plates, each having one or more windshield attachment points 70. In such an embodiment, the back bracket plate 62 may be provided as several independent plates or units, each approximately surrounding a windshield attachment point 70 and associated attachment hardware. Such an embodiment is illustrated in FIG. 32.

FIG. 32 shows a plan view of an embodiment incorporating multiple separate front bracket plates 60 and back bracket plates 62, as well as the attachment hardware illustrated in FIGS. 28-29. Those of skill in the art will readily appreciate that the shapes of the front bracket plates 60 and back bracket plates 62 illustrated, as well as the choice of attachment hardware illustrated is merely illustrative and will readily understand modifications that may be made to the embodiment illustrated in FIG. 32. The illustration in FIG. 32 includes a portion of the motorcycle fairing 52. The illustrated shape of the fairing 52 is for illustrative purposes only. Attached to the fairing 52 are three front bracket plates 60. One of skill in the art will appreciate that the front bracket plates 60 could be attached to another portion of the motorcycle besides the fairing 52. Additionally, one of skill in the art will appreciate that a portion of the fairing 52 or the motorcycle itself could serve as the front bracket plates 60 (or alternatively as the back bracket plates 62, when the attachment hardware is actuated from the front side).

In the embodiment illustrated in FIG. 32, back bracket plates 62 are associated with and attached to the front bracket plates 60 by the attachment hardware. Specifically, in the embodiment illustrated in FIG. 32, the back bracket plates 62 are secured to the front bracket plates 60 by the shafts 124 (not shown) attached to the cams 126. Actuation of the individual cams 126 allows additional separation between the back bracket plates 62 and the front bracket plates 60, allowing insertion and/or removal of the quickly-detachable windshield 50, as discussed above. In some embodiments, more or fewer windshield attachment points 70 may be provided, as discussed above.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A quickly-detachable windshield system capable of tool-free quick attachment and removal of a windshield to a motorcycle fairing comprising:
a motorcycle fairing;
a windshield mounting bracket that is affixed to the motorcycle fairing and is configured to receive the substantially-vertical insertion of a windshield, the windshield mounting bracket comprising:
a front member; and
a back member;
rapid attachment hardware capable of actuation without the use of tools affixed to the windshield mounting bracket wherein at least a portion of the rapid attachment hardware is located between the front member and the back member; and
a windshield configured to engage the rapid attachment hardware and inserted into the windshield mounting bracket between the front member and the back member so as to engage the rapid attachment hardware.

2. The system of claim 1 wherein at least a portion of the windshield mounting bracket is manufactured into the motorcycle fairing.

3. The system of claim 1 wherein the windshield mounting bracket comprises a front plate that is the front member and a back plate that is the back member.

4. The system of claim 1 wherein the windshield mounting bracket comprises:
a front plate that is the front member; and
a back plate that is the back member, wherein the front plate is attached to the back plate in such a way as to define a gap between the front plate and the back plate sized to receive the windshield.

5. The system of claim 1 wherein the windshield mounting bracket comprises:
a front plate that is the front member;
a center plate; and
a back plate that is the back member, wherein the center plate is attached between the front plate and the back plate in such a way as to define a gap between the front plate and the back plate sized to receive the windshield.

6. The system of claim 1 wherein the rapid attachment hardware comprises:
a spring disposed within the windshield mounting bracket;
a plunger head disposed within the windshield mounting bracket and engaged against the spring;
a plunger shaft attached to the plunger head and sized to extend outside the windshield mounting bracket at a location where an individual may apply force to the plunger shaft.

7. The system of claim 6 wherein at least a portion of the plunger shaft is detachable from at least one of the plunger shaft and the plunger head.

8. The system of claim 1 wherein the rapid attachment hardware comprises a rotatable lock disposed within the windshield mounting bracket.

9. The system of claim 1 wherein the rapid attachment hardware comprises a pivoting lock disposed within the windshield mounting bracket.

10. The system of claim 1 wherein the rapid attachment hardware comprises a center spring clip disposed within the windshield mounting bracket.

11. The system of claim 1 wherein the rapid attachment hardware comprises a spring lock disposed within the windshield mounting bracket comprising:
a spring;
an anchor fixing one end of the spring to the windshield mounting bracket; and
a lock head attached to the other end of the spring.

12. The system of claim 1 wherein the rapid attachment hardware comprises an elastically-deformable clip disposed within the windshield mounting bracket.

13. The system of claim 1 wherein the windshield is formed from a unitary piece of a single material.

14. The system of claim 1 wherein the rapid attachment hardware comprises a mechanism for reversibly clamping the windshield between the front member and the back member.

15. The system of claim 14 wherein the mechanism for reversibly clamping the windshield between the front member and the back member comprises a mechanism selected from the group of:
a cam; and
a rotating handle and separators configured to engage the rotating handle in a first rotational position and to not engage the rotating handle in a second rotating position.

16. The system of claim 1 wherein the rapid attachment hardware comprises a mechanism for reversibly clamping the windshield between the front member and the back member selected from the group of:
a cam and pivot pin attached to a shaft; and
a rotating handle attached to a shaft and a separator configured to engage the rotating handle in a first rotational position of the rotating handle and to not engage the rotating handle in a second rotational position of the rotating handle.

17. A method for providing for the tool-free rapid release and changing of a windshield on a recreational vehicle, the method comprising the steps of:
providing a recreational vehicle;
attaching a windshield mounting bracket including rapid attachment hardware that is capable of actuation without the use of tools to the recreational vehicle;
inserting a windshield configured to engage the rapid attachment hardware of the windshield mounting bracket into the windshield mounting bracket until the windshield engages the rapid attachment hardware.

18. The method of claim 17 further comprising the steps of:
actuating the rapid attachment hardware so that the rapid attachment hardware disengages the windshield;
removing the windshield.

19. A method for providing for the rapid release and changing of a motorcycle windshield, the method comprising the steps of:
providing a motorcycle having a windshield mounting receptacle;
providing rapid attachment hardware capable of actuation without the use of tools disposed at least partially within the windshield mounting receptacle;
inserting a windshield configured to engage the rapid attachment hardware of the windshield mounting receptacle until the windshield engages the rapid attachment hardware.

20. The method of claim 19 further comprising the steps of:
actuating the rapid attachment hardware so that the rapid attachment hardware disengages the windshield;
removing the windshield;
inserting a replacement windshield configured to engage the rapid attachment hardware of the windshield mounting receptacle until the replacement windshield engages the rapid attachment hardware.
